(19) United States
(12) Patent Application Publication
(10) Pub. No.: US 2013/0239760 A1
(43) Pub. Date: Sep. 19, 2013

(54) SPRINKLER REPAIR PLIERS

(71) Applicant: JAMES LUCAS, Winter Park, FL (US)

(72) Inventor: JAMES LUCAS, Winter Park, FL (US)

(21) Appl. No.: 13/422,632

(22) Filed: Mar. 16, 2012

(51) Int. Cl. B25B 7/02

(52) U.S. Cl. 81/421; 81/426.5

(57) ABSTRACT

Sprinkler repair pliers include a pair of opposed plier halves, each having a handle, an overlapping middle section, and a top section forming a semi-circular gripping jaw. A fulcrum pin connects the middle sections in a see-saw manner, and a spring imparts a pressure onto each handle to maintain the pliers in the closed position. The pliers acting to engage a tubular device via the gripping jaws by imparting a uniform pressure across a 360 degree diameter.

### TECHNICAL FIELD

The present invention relates generally to irrigation tools, and more particularly to pliers for engaging and repairing pop-up style sprinkler heads.

### BACKGROUND

The statements in this section merely provide background information related to the present disclosure and may not constitute prior art.

Irrigation systems are utilized throughout the world to provide water to lawns and gardens in both home and agricultural settings. One popular element of these sprinkler systems includes the conventional pop-up sprinkler head 1, that is illustrated in FIG. 1. As shown, pop up sprinkler heads typically include a main body 2 that is positioned underground having a bottom section 3 that connects to a water supply line, and a cap 4 that rests on the surface of the ground. A retractable riser 5 is typically connected to the main body by a spring 6 in order to deliver water to the lawn via a nozzle 7.

The sprinkler spring 6 acts to keep the riser 5 retracted within the main body when the sprinkler is not in use. Alternatively, whenever water is supplied to the device, the force of the water overcomes the resistance of the spring 6, causing the riser 5 to extend upward, above the surface of the ground in order to effectively discharge the water.

Sprinkler heads are typically constructed from lightweight and fragile materials such as PVC or plastic, for example which become brittle over time and are easily damaged by activities such as lawn mowing, raking and trimming, for example. As such, one common issue experienced by those who own or maintain sprinkler systems revolves around the need to repair damaged sprinkler heads.

The first step to repairing a damage sprinkler often revolves around finding its location. To this end, a user will typically turn on the water in order to extend the riser 5 above the ground. At this time, if the user wishes to work on the sprinkler with the riser in an extended position, they must keep the water running, thus exposing themselves to the spraying water. Alternatively, once the riser is exposed, the user can place a flag or other identification device near the sprinkler head in order to identify its location. After placing the flag, the user can shut off the water, which in turn causes the riser to retract into the main body, before returning to the location of the flag to begin working on the sprinkler. Owing to the retracted position of sprinkler, the user must now attempt to manually extract the riser 5 using conventional tools such as screwdrivers, pliers and the like.

As shown in FIG. 1b, when engaged by conventional pliers 9, the entire force of the pliers are applied to a small surface area S of the tubular sprinkler elements. This uneven application of force often results in additional damage/cracking of the sprinkler components.

Moreover, conventional pliers are unable to engage and maintain the riser in an extended position without requiring the user to apply a constant pressure to the device.

Accordingly, it would be beneficial to provide sprinkler repair pliers capable of allowing a user to easily and quickly engage tubular sprinkler heads, and to maintain the riser in an exposed position without suffering from the drawbacks described above.

### SUMMARY OF THE INVENTION

The present invention is directed to sprinkler repair pliers. One embodiment of the present invention can include a pair of opposed plier halves, each having a handle, an overlapping middle section, and a top section forming a semi-circular gripping jaw. A fulcrum pin can connect the middle sections in a see-saw manner, and

a spring can impart a pressure onto each handle to maintain the pliers in the closed position. The pliers acting to engage a tubular device via the gripping jaws by imparting a uniform pressure across a 360 degree diameter.

Another embodiment of the present invention can include non-stick tread disposed onto each of the gripping jaws in order to increase the coefficient of friction of the pliers when in operation.

Yet another embodiment of the present invention can include a circular engagement area having a diameter sized to engage tubular devices of known dimensions.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1a is a frontal view of a conventional tool engaging a pop-up sprinkler head in accordance with background art.

FIG. 1b is a cutout top view of a conventional tool engaging a pop-up sprinkler head in accordance with background art.

FIG. 2 is a front view of a sprinkler repair plier in accordance with one embodiment of the invention.

FIG. 3 is a front view of the sprinkler repair pliers in an open position, in accordance with one embodiment of the invention.

FIG. 4 is a top view of the sprinkler repair pliers in operation in accordance with one embodiment of the invention.

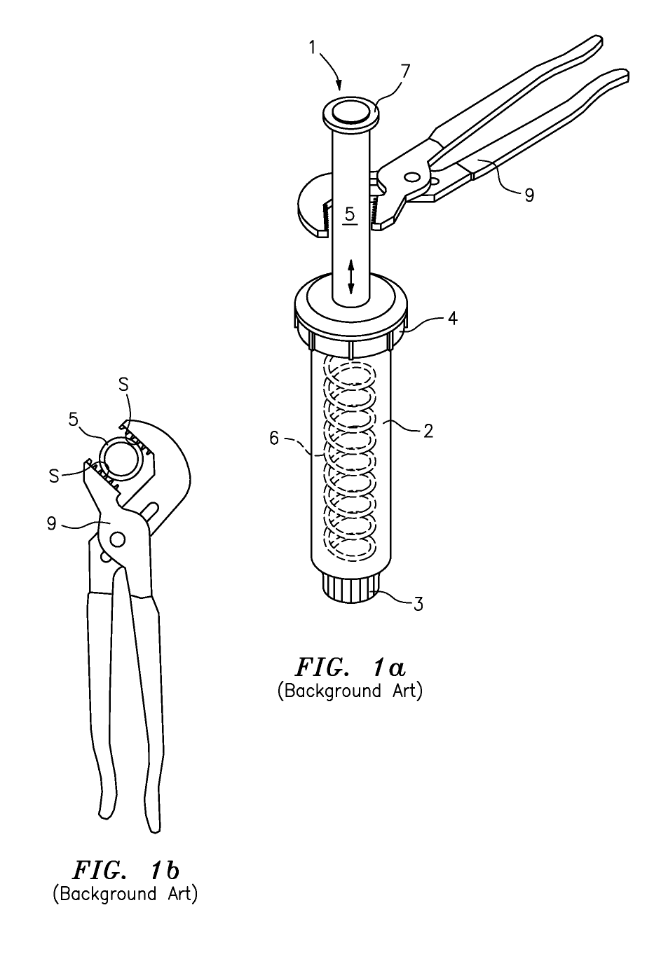

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

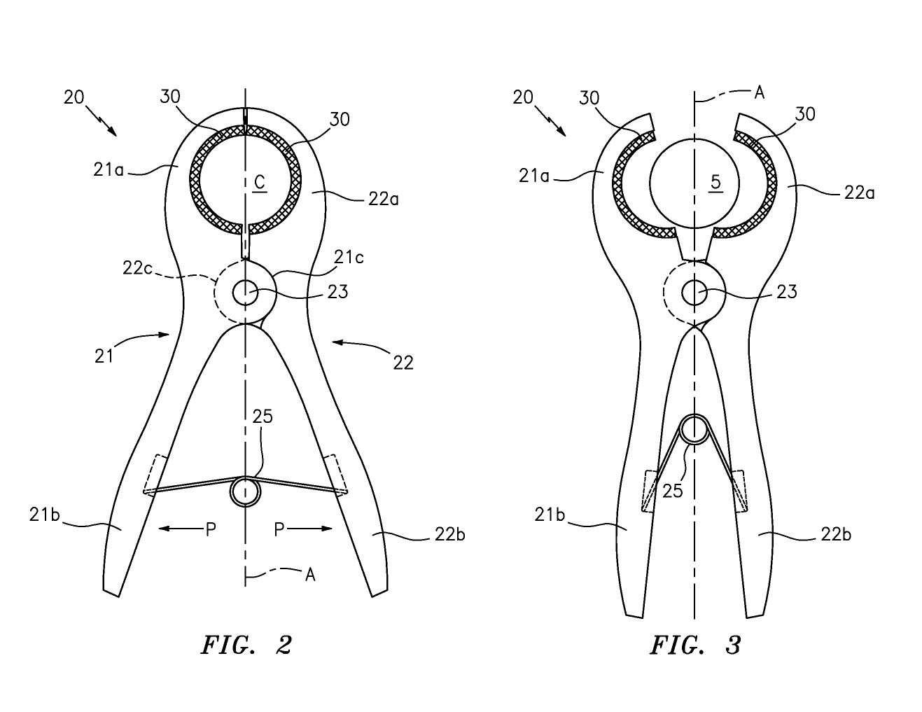

For purposes of this description, the terms “upper,” “bottom,” “right,” “left,” “front,” “vertical,” “horizontal,” and derivatives thereof shall relate to the invention as oriented in FIG. 2. Although described throughout this disclosure as for use with sprinkler risers, other uses are anticipated. For example, the device 20 can be used to work on virtually any object having a rounded shape such as a pipe, hose or other such article.

FIG. 2 illustrates one embodiment of sprinkler repair pliers 20 that are useful for understanding the inventive concepts disclosed herein. As shown, pliers 20 can include a pair of opposed plier halves 21 and 22. Each plier half includes a gripping jaw 21a and 22a, respectively at top section, and an elongated shaft 21b and 22b, respectively forming a handle along a bottom section thereof. The pliers also include overlapping sections 21c and 22c which act to pivotally connect each half of the pliers 21 and 22, respectively, together along a central axis A via a fulcrum pin 23.

Fulcrum pins 23 are extremely well known in the art, and act to secure the overlapping portions of each side of the pliers together in a manner that allows each half to rotate about the pin itself. In one embodiment, the fulcrum pin can be constructed from a strong metallic material such as steel or aluminum, however other construction materials such as plastic and PVC, for example, are also contemplated. The installation and functionality of fulcrum pins being clear from the illustrations and general knowledge of those skilled in the art, no further description will be provided.

Each of the opposed gripping jaws 21a and 22a can include a semi-circular shape and can act in combination to form a circular engagement area C when the device is in a closed/engaged position. To this end, the pliers can be constructed specifically for use with specific size pipes, such as ½″, ¾″ and 1″, for example. Of course one of skill in the art will recognize that the pliers can be constructed with an engagement area sufficient to grip virtually any size pipe/sprinkler element.

As shown, the inside portion of each gripping jaw can further include nonskid tread 30 which will act to increase the traction and grip of the pliers when engaging foreign objects having a tubular shape. Tread 30 can be constructed from any number of known materials capable of increasing the coefficient of friction of the gripping jaws in a wet environment. Several non-limiting examples include strips of rubber that are glued to the inside surface of the gripping jaws, as well as conventional anti-skid coatings/agents.

As will be explained below, the gripping jaws 21a and 22a can act to securely grip a tubular device, such as a sprinkler riser 5, for example in a 360° manner thus applying an even pressure to the entire circumference of the device. Moreover, by including tread 40 onto the gripping jaws, the pliers can function more effectively in wet environment conditions without requiring the user to apply additional force. Such a feature can act to greatly reduce the risk of further damage to the intended device.

In one preferred embodiment, the pliers 20 can be constructed from a sturdy material such as PVC or hardened plastic, for example, having excellent tensile strength and waterproof qualities. However, other materials including but not limited to aluminum and injection molded plastic, for example are also contemplated.

A spring 25 or other known resilient torsional device can be interposed between each of the handle sections 21b and 22b in order to hold or otherwise retain the gripping jaws in a closed position. To this end, the spring 25 can be secured to the handles in a coiled configuration so as to constantly apply outward pressure P (i.e., in a direction that is perpendicular to, and away from the central axis A) to each of the handle sections.

In one preferred embodiment, the spring 25 will be secured to each of the handles via a permanent bonding agent such as glue, or metal quickset, for example. However other conventional attachment means such as solder are also contemplated. In one alternate example (not illustrated) each handle section can include an opening/pocket into which the end portions of the spring can be secured. As such, the spring can be secured to each handle in order to apply a constant pressure in any conventional manner and utilizing any conventional material.

FIG. 3 illustrates one embodiment of the device 20 in an open configuration for gripping a sprinkler element. As shown, when handle sections 21b and 22b are squeezed towards the central axis A, the fulcrum pin 24 transfers an opposite pressure onto the gripping jaws 21a and 22a, respectively, in order to open the jaws in a see-saw manner.

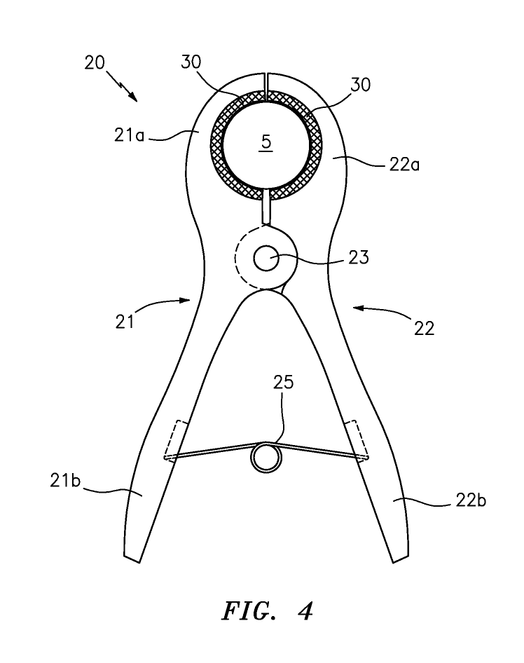

As shown in FIG. 4, once surrounding a work item such as the illustrated sprinkler riser 5, a user can reduce the pressure on the plier handles causing the gripping jaws 21a and 22a to close around the riser 5 and to maintain a constant pressure across the 360° circumference/surface area of the sprinkler riser.

Accordingly, the sprinkler repair pliers 20 described herein can effectively engage tubular elements by applying a uniform pressure across a 360° surface area in a novel fashion. Moreover, by incorporating a spring 25 to apply constant pressure to the jaws, a user can clamp the pliers onto a riser 5 in an extended position, and then shut off the water to the sprinkler. When so attached, the presence of the pliers will act to prevent the riser from retracting into the main body 2. As such, the pliers also act as a tool for locating damaged sprinklers by providing a visual aid to the user.

As described herein, one or more elements of the pliers 20 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individual elements such as the plier halves 21 and 22, the gripping jaws 21a and 22a, and the gripping area 30, including all sub components, for example, may be formed as one continuous element, either through manufacturing processes, such as welding, casting, or molding, or through the use of a singular piece of material milled or machined with the aforementioned components forming identifiable sections thereof. Accordingly, in one embodiment, each half of the pliers can be constructed from injection molded plastic having a height and dimension suitable for engaging tubular sprinkler components having a known dimension/diameter. Of course, other materials such as metal and rigid plastic are also contemplated.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. Sprinkler repair pliers, comprising:
a pair of opposed plier halves, each of said halves including
an elongated bottom section forming a handle,
an overlapping middle section, and
a top section forming a semi-circular gripping jaw, each of said gripping jaws being configured to form a circular engagement area when the pliers are in a closed position;
a fulcrum pin connecting the middle section of each of the plier halves, said pin being configured to allow each of the plier halves to move in a see-saw manner; and
a spring interposed between the handle of each of the plier halves, said spring being configured to impart a pressure onto each handle to maintain the pliers in the closed position,
wherein said pliers are configured to engage a tubular device via the gripping jaws by imparting a uniform pressure across a 360 degree diameter of the device.

2. The pliers of claim 1, wherein each of said gripping jaws further includes a tread configured to increase a coefficient of friction of the pliers.

3. The pliers of claim 2, wherein said tread includes strips of rubber glued to an inside surface of each of the gripping jaws.

4. The pliers of claim 2, wherein said tread includes a non-stick coating applied to an inside surface of each of the gripping jaws.

5. The pliers of claim 1, wherein said engagement area includes a diameter of one-half inch in the closed position.

6. The pliers of claim 1, wherein said engagement area includes a diameter of three quarters of an inch in the closed position.

7. The pliers of claim 1, wherein said engagement area includes a diameter of one inch in the closed position.
